(19) United States
(12) Patent Application Publication
(10) Pub. No.: US 2006/0044685 A1
(43) Pub. Date: Mar. 2, 2006

(54) Recording disk cartridge

(75) Inventor: Kengo Oishi, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/195,682

(22) Filed: Aug. 3, 2005

(30) Foreign Application Priority Data
Aug. 30, 2004 (JP) 2004-249590

(51) Int. Cl. G11B 23/03

(52) U.S. Cl. 360/133

(57) ABSTRACT

A recording disk cartridge has a plurality of flexible recording disk media integrally rotatably housed within a cartridge case which comprises a lower plate for configuring a lower wall parallel to said plurality of the recording disk media, at least one inner plate that is stacked and fixed on said lower plate and partitions said plurality of the recording disk media, a shutter that opens and closes a case opening which is formed in a portion of a side wall configured by the lower plate and the inner plate and the upper plate, wherein the shutter comprises a lower rotor which is rotatably supported in an inner side of the lower plate, an upper rotor which is rotatably supported in an inner side of the upper plate and a shutter plate that couples both the lower rotor and the upper rotor and shuts off the case opening.

### BACKGROUND OF THE INVENTION

1. Field of the Invention

The present invention relates to a recording disk cartridge comprising a plurality of flexible recording disk media.

2. Description of the Related Art

Conventionally, as a recording disk medium a flexible recording disk medium is known where a magnetic layer is formed on both faces of a disc-form support body consisting of a flexible material such as a polyester sheet. Although the magnetic disk medium has a merit of speedily accessing data in comparison with a magnetic tape, on the other hand, it has a demerit of a memory capacity being small because a recording area thereof is small.

In order to solve the demerit of the flexible magnetic disk medium, it is conventionally disclosed a magnetic disk cartridge for housing a plurality of magnetic disk media in one cartridge case (for example, see JP 2004-22011A).

In this connection, because a flexible magnetic disk medium is low in rigidity thereof, there is a problem that the medium tends to vibrate in a vertical direction for a recording face when rotated. Therefore, in an invention of JP 2004-22011A each magnetic disk medium is made a configuration of being pinched by shutters. Thus by arranging plate members of high rigidity such as the shutters in a vicinity of the magnetic disk medium, the recording face can be stabilized because the medium becomes along the plate members, accompanied with a rotation of the medium.

However, because a magnetic disk cartridge of JP 2004-22011A is configured of movable shutters arranged by four for one magnetic disk medium, there is a problem that the cartridge is complicated in a structure thereof and is difficult to keep a parallelism to the medium. In addition, because the magnetic disk cartridge is mass produced goods, it is preferable to be excellent in assembling capability and productivity. Furthermore, the magnetic disk cartridge is preferable to be high in a degree of freedom in a design change so as to easily set a plurality of kinds thereof where number of magnetic disk media is made three, five and the like.

Considering the function of the shutter in the invention taught by JP 2004-22011A (called as the reference 1, hereinafter), every magnetic disc is adjoined with a different shutter and therefore the outer dimension of the physical thickness of the cartridge increases more than the simple increment of the number of recording disk media.

In order to solve the deficiency of the exiting invention taught by the reference 1, the present invention provides a simple cartridge structure with easy assembling capability and high producible capability that facilitate to change the quantity of the installed disc media. These result in a compact and simple structure of the recording disc cartridge with a shutter.

### SUMMARY OF THE INVENTION

A recording disk cartridge of the present invention is one where a plurality of flexible recording disk media is integrally rotatably housed within a cartridge case comprising: a lower plate for configuring a lower wall parallel to the plurality of the recording disk media; at least one inner plate that is stacked and fixed on the lower plate and partitions the plurality of the recording disk media; and an upper plate that is stacked and fixed on the inner plate, a case opening formed in the side wall and a shutter that opens and closes the case opening wherein the shutter comprises a shutter plate that shuts off the case opening of which edges are configured with the lower plate and the upper plate both of which insides a lower rotor and an upper rotor are, respectively, coupled.

In accordance with such the configuration, in the recording disk cartridge of the present invention the cartridge case is configured in a form of stacking up the lower plate, the inner plate and the upper plate. Therefore, a pair of the inner plate and the recording disk medium is made one unit, all inner plates can be made a same part and therefore, the recording disk cartridge is excellent in productivity. And because the recording disk medium in an assembling process can also be carried by making a lower plate and an inner plate as a substitute of a tray, the recording disk cartridge is excellent also in assembling capability without damaging and staining the medium. In addition, in a case that it is intended to make a specification of changing a number of recording disk media, it is easy to change the specification because it suffices to mainly change a number of inner plates. Furthermore, because an inner plate of a partition plate is fixed as part of the cartridge case, the recording disk cartridge is easy to realize accuracy such as a parallelism to the recording disk media and can heighten a rotational stability especially at a high speed such as 2000 to 8000 rpm. Since a single shutter plate can open and close the case opening, the construction of the shutter can be simplified and therefore contribute to compactization of the physical dimensions of the recording disk cartridge. Since the shutter is formed with the lower rotor and coupled with the upper rotor to be integrally rotatable, the open/close of the shutter can behave in a good repeatable manner.

Since the shutter plate is formed with either the lower rotor or the upper rotor, it is possible to shorten the assembly process of the shutter. It is also possible to be flexible in changing of the quantity of the media set in the recording disk cartridge by independently assembling the lower rotor, the upper rotor and the shutter so that the height of the shutter plate is changed in accordance to the quantity of media set in the recording disk cartridge.

At least either the lower rotor or the upper rotor has a shutter guiding groove wherein the shutter guiding groove has a wider opening in the mating surface to the shutter plate, the shutter plate has the edges wherein the shutter plate has a thin thickness at the mating edge against the shutter guiding groove or both configurations of such shutter guiding groove and the shutter plate have the forms as described are adopted. Then it is easily to mate the shutter plate with the shutter guiding groove so that the improvement of assembly can be obtained.

The shutter has a mating portion which mates with shutter open/close supporting portion formed in the disk drive so that the mating portion transmits a rotation force to the shutter mechanism. Therefore it is possible to transmit the linear force of setting and ejecting the recording disk cartridge in a rotation force to and from the disk drive and to simplify the structure of the shutter.

In order not to de-guide the upper rotor from the upper plate, the upper rotor is stopped by a stopper which is formed with the upper plate. Then the upper plat and the upper rotor are unified and the positioning of these parts can be easy when the rotor and the shutter plate are assembled. The upper rotor and the upper plate are not de-guided even when they are downwardly held and therefore it is easy to assemble the recording disk cartridge. Moreover, the upper plate is the upper position in many cases when the recording disk cartridge is used and then it is possible to rotate the shutter as far as the upper rotor is stopped against the upper plate in a good repeatable manner.

In accordance with such the configuration, in the recording disk cartridge of the present invention the cartridge case is configured in a form of stacking up the lower plate, the inner plate and the upper plate. Therefore, a pair of the inner plate and the recording disk medium is made one unit, all inner plates can be made a same part and therefore, the recording disk cartridge is excellent in productivity. And because the recording disk medium in an assembling process can also be carried by making a lower plate and an inner plate as a substitute of a tray, the recording disk cartridge is excellent also in assembling capability without damaging and staining the medium. In addition, in a case that it is intended to make a specification of changing a number of recording disk media, it is easy to change the specification because it suffices to mainly change a number of inner plates.

Furthermore, it is possible to obtain a recording disk cartridge with a shutter in a simple structure.

### BRIEF DESCRIPTION OF THE DRAWINGS

FIG. 1 is an exploded perspective view of a magnetic disk cartridge related to an embodiment of the present invention.

FIG. 2A is an external perspective view of a magnetic disk cartridge with a shutter closed related to an embodiment of the present invention

FIG. 2B is an external perspective view with the shutter opened related to the magnetic disk cartridge.

FIG. 3 is a perspective view showing an inner face of an upper plate.

FIG. 4 is a section view taken along a line IV-IV in FIG. 2B of the magnetic disk cartridge loaded on a magnetic disk drive.

FIG. 5 is a partially enlarged drawing of FIG. 4.

FIG. 6 is an exploded perspective view showing a stack structure of magnetic disk media.

FIG. 7 is a section view showing mating status of a shutter and an upper rotor regarding an embodiment.

FIG. 8 is a section view showing mating status of a shutter and an upper rotor regarding another embodiment.

FIG. 9 is a section view of mating status of parts composing a shutter regarding another embodiment.

FIG. 10 is an external perspective view of recording disk cartridge which is closed, particularly, shows another embodiment of a mating portion of a shutter open/close mechanism.

FIG. 11A is a perspective view showing inside of an upper plate, especially, shows an embodiment of mating status of an upper rotor and an upper plate.

FIG. 11B is a perspective view showing inside of an upper plate, especially, shows another embodiment of mating status of an upper rotor and an upper plate.

### DESCRIPTION OF THE PREFERRED EMBODIMENTS

Here will be described an embodiment of the present invention in detail, referring to drawings as needed. In the embodiment will be described a case of adopting a magnetic disk medium as an example of a recording disk medium.

Meanwhile, in a description below, with respect to up/down directions, making it a standard a typical use state of the magnetic disk cartridge, vertical directions for faces of magnetic disk media are called the up/down directions for convenience.

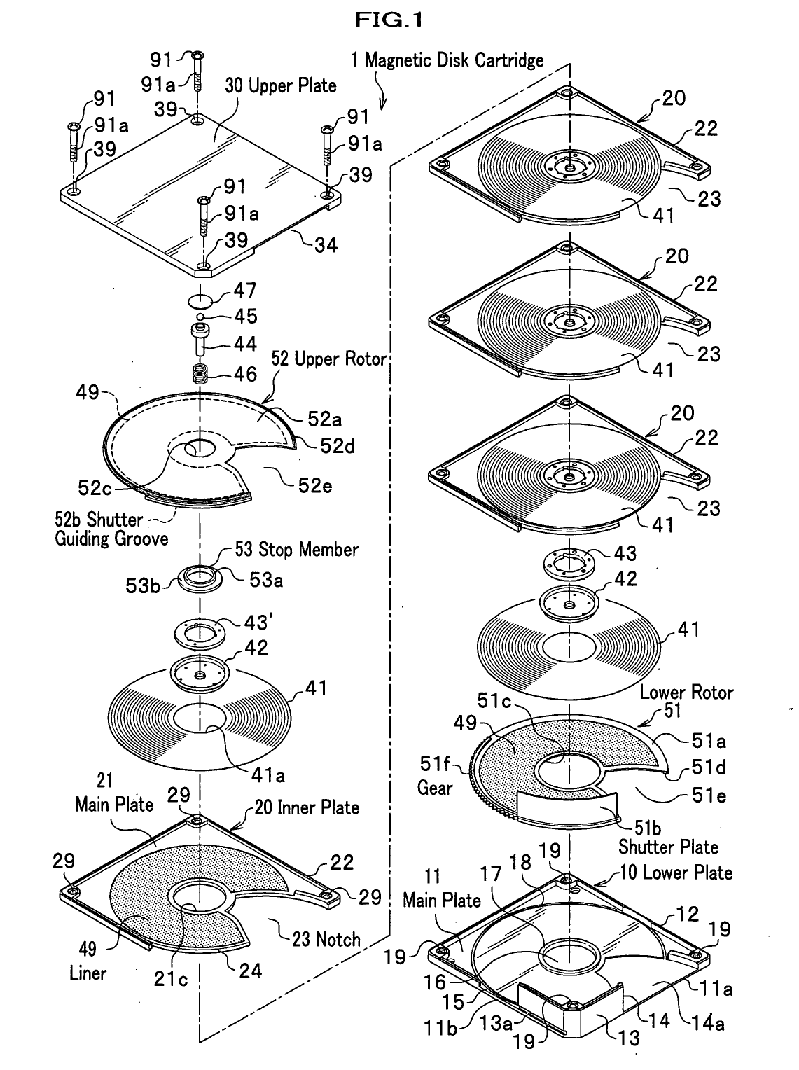

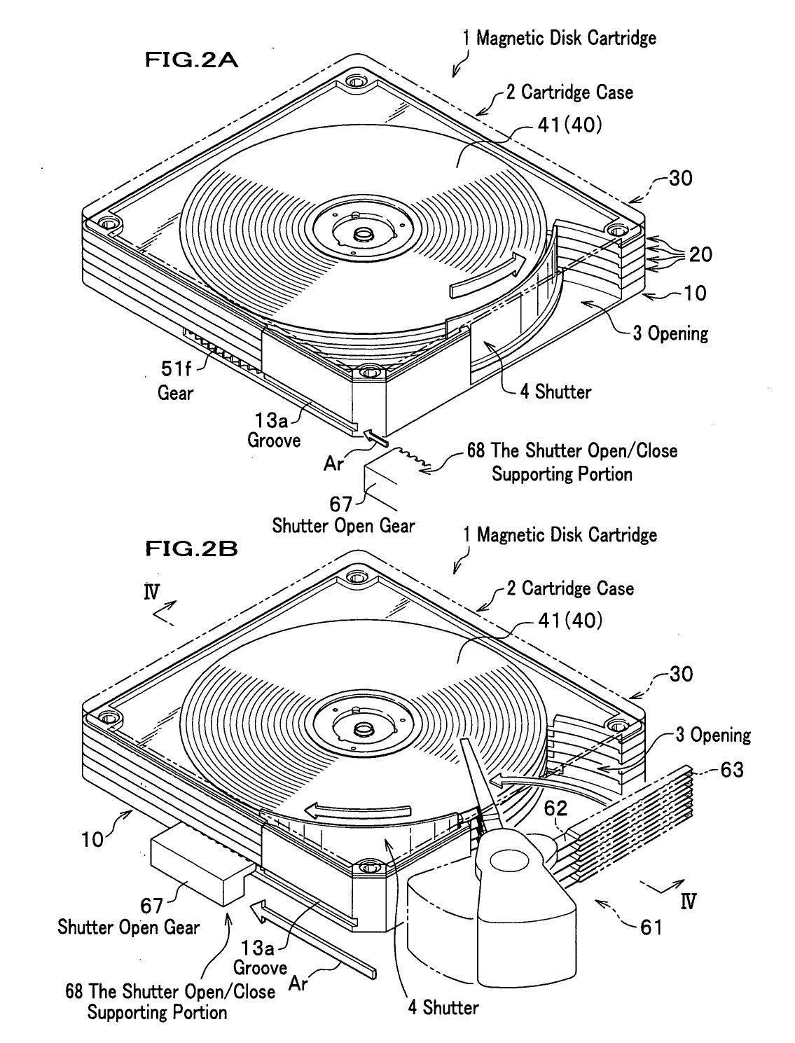

As shown in FIG. 1, in a magnetic disk cartridge 1 of an example of a recording disk cartridge are stacked a lower plate 10 for configuring a lower wall thereof; a plurality of, for example, four inner plates 20 and an upper plate 30 for configuring an upper wall thereof in this order; these are fastened and fixed with four screws 91 and thereby a cartridge case 2 (see FIG. 2A) is configured. Between the lower plate 10 and the lowermost inner plate 20, between any adjacent two of the four inner plates 20 and between the uppermost inner plate 20 and the upper plate 30 is arranged a magnetic disk medium 41, respectively. Each magnetic disk medium 41 is a disc form having an opening 41a at center thereof and a center core 42 made of metal is affixed at rim of the opening 41a. It is designed that any adjacent two center cores 42 are engaged by spacers 43, 43′ and that five magnetic disk media 41 (the magnetic disk media 41 stacked and integrated are assumed to be a disk stack 40) are integrally rotated.

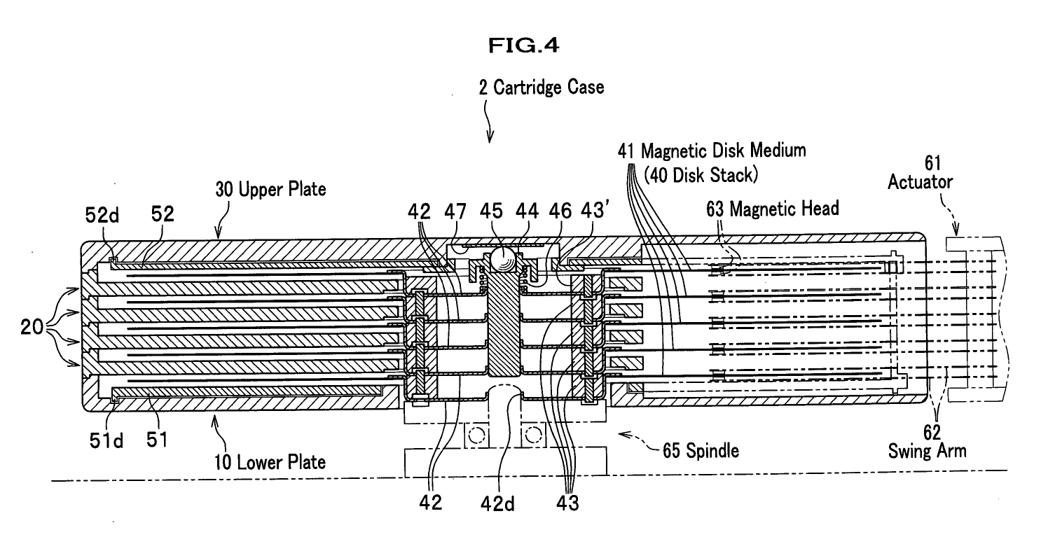

In each of the inner plates 20 is formed a rib 22 for abutting with upper/lower plates at a peripheral rim of a flat main plate 21. Part of a right near side of each of the inner plates 20 in FIG. 1 forms a notch 23 so that magnetic heads 63 (see FIG. 4) can easily move onto the magnetic disk media 41. At the portion of the notch 23 is not formed the rib 22 and therefore, when the inner plates 20 are stacked up, an opening 3 is formed on a side face of the cartridge case 2 as shown in FIG. 2A.

The opening 3 is opened/closed by a shutter 4 that coaxially rotates with the disk stack 40. As shown in FIG. 1, the shutter 4 is configured by combining a lower rotor 51 and an upper rotor 52.

Next will be described each member in more detail.

The lower plate 10 is designed at a peripheral rim of a main plate 11 of a substantially square to mainly form a side wall 13 and a rib 12 for abutting with a lower face of the rib 22 of the lowermost inner plate 20. The side wall 13 is vertically provided in a predetermined range, for example, around one third range of one edge, from one corner of the main plate 11 (near side corner in FIG. 1) and is formed approximately in height of the inner plates 20 stacked.

A sector portion toward a center of the main plate 11 from one edge 11a (one edge of right near side in FIG. 1) continuing into the side wall 13 of the main plate 11 is designed to form a depression 14a lowered by one step, not to form the rib 12 at the peripheral rim of the main plate 11 and to become an opening 14. Thus it becomes easy for the magnetic heads 63 to proceed into the cartridge case 2.

An approximately central one third range of the other edge 11b (one edge of left near side in FIG. 1) continuing into the side wall 13 of the main plate 11 is designed not to form the rib 12 but to become an opening 15 so that a gear 51f of the lower rotor 51 described later can be exposed. In addition, outside the side wall 13 of the other edge 11b is formed a groove 13a along a periphery of the lower plate 10, continuing into the opening 15. The groove 13a is designed to be a passage where a shutter open gear 67 (see FIG. 2A) of a magnetic disk drive proceeds in a direction shown in an arrow of FIG. 2A and enters in the opening 15 in order to engage in the gear 51f.

The rib 12 is formed so as to protrude upward across all periphery except the side wall 13 and the openings 14,15 out of a peripheral rim of the main plate 11. At center of the main plate 11 is formed a circular opening 16 for exposing the center core 42 provided inside the lowermost magnetic disk medium 41. At upper rim of the opening 16, across all periphery thereof is formed a rib 17 outside which a central opening 51c formed at center of the lower rotor 51 fits. The rib 17 rotationally freely supports the lower rotor 51.

In addition, on an upper face (inner face) of the main plate 11 is formed a circular lower rotor support groove 18 at a position corresponding to peripheral rim of the lower rotor 51. The lower rotor support groove 18 rotationally freely supports the lower rotor 51 coaxially with the magnetic disk media 41 by engaging in a rib 51d (see FIG. 4) formed downward at a peripheral rim of the lower rotor 51.

In addition, at four corners of the main plate 11 are formed screw holes 19 where female threads are formed, respectively, with penetrating through the up/down directions.

The main plate 21 of each of the inner plates 20 is substantially a square and a portion corresponding to one of four corners of the square is designed to be an arc (arc portion 24) one size larger than the magnetic disk medium 41. At one edge (right near side in FIG. 1) continuing into the arc portion 24 is formed the notch 23 into a sector. The rib 22 protrudes the up/down directions and is formed across all periphery except the arc portion 24 and the notch 23 out of periphery rim of the main plate 21. At center of the main plate 21 is formed a central opening 21c for enabling the upper center core 42 to be exposed and to be coupled with the lower center core 42.

In addition, at three corners of the main plate 21, with penetrating through the three corners in the up/down directions, are formed holes 29 through which screw shaft portions 91a of the screws 91 are inserted, respectively.

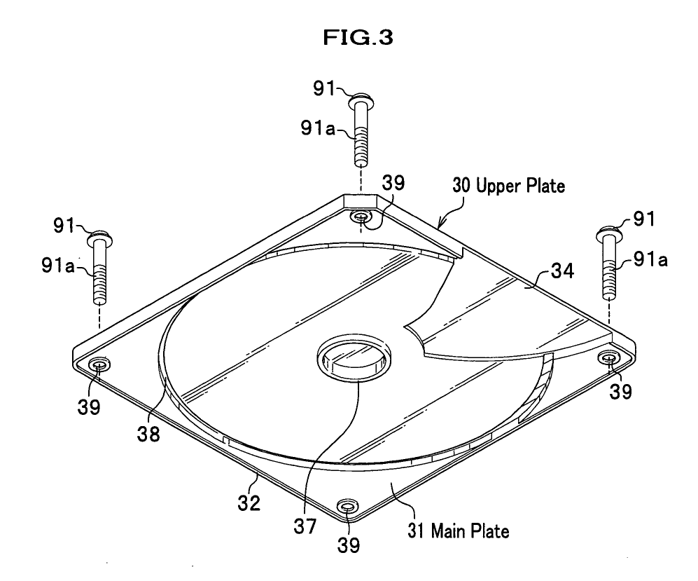

The upper plate 30 is formed substantially symmetric to the lower plate 10. As shown in FIG. 3, in the upper plate 30, on a substantially square main plate 31 are formed a depression 34 corresponding to the depression 14a, a rib 37 corresponding to the rib 17 and an upper rotor support groove 38 corresponding to the lower rotor support groove 18. Meanwhile, at center of the main plate 31 are not formed an opening and a side wall corresponding to the side wall 13.

In addition, at a peripheral rim of the main plate 31, across all periphery except the depression 34 is formed a rib 32 protruding downward.

In addition, at four corners of the main plate 31 are respectively formed holes 39 that enables the screw shaft portions 91a of the screws 91 to be penetrated therethrough.

The lower rotor 51 is designed so that: a central opening 51c, a notch 51e, a rib 51d and the gear 51f are formed on a ring-form lower rotor plate 51a substantially same as the magnetic disk media 41; and a shutter plate 51b is vertically provided at the peripheral rim of the lower rotor plate 51a. The central opening 51c is formed as a circle fitting outside the rib 17, the notch 51e is formed as a sector corresponding to the depression 14a. In addition, the rib 51d is provided downward at a peripheral rim of a lower face of the lower rotor plate 51a, corresponding to the lower rotor support groove 18.

The shutter plate 51b is a blocking member for blocking the opening 3 (see FIG. 2A) and the disk stack 40, is vertically provided along the peripheral rim of the lower rotor plate 51a with neighboring the notch 51e and is formed in a single block with the lower rotor 51 along the outer peripheral of the lower rotor plate 51a.

The gear 51f is an engaged portion for opening/closing the shutter 4 (see FIG. 2A) from outside of the magnetic disk cartridge 1 and is formed at a peripheral rim of the lower rotor plate 51a within a predetermined range with neighboring the shutter plate 51b. The gear 51f matches with the shutter open gear 67 (see FIG. 2A) which is an example of the shutter open/close supporting portion 68 and has a function to transmit a motion by changing the linear motion of setting or ejecting the recording disk cartridge 1 to a magnetic disk drive which is not depicted in figures in a rotational motion for the shutter 4.

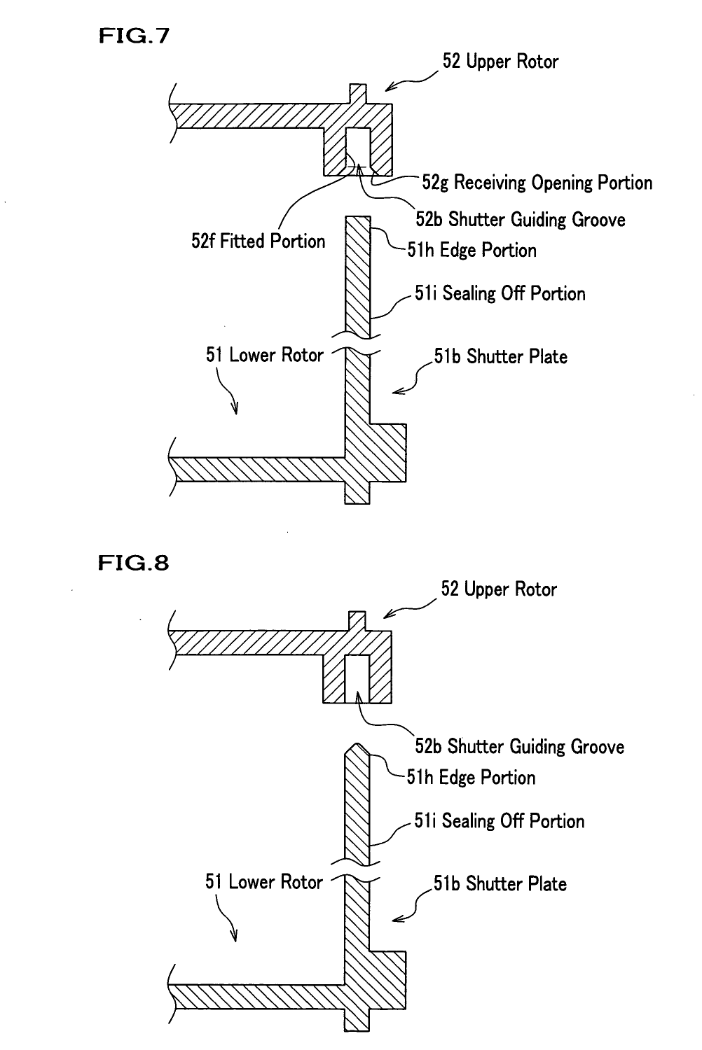

The upper rotor 52 is designed to be substantially symmetric to the lower rotor 51: the upper rotor 52 comprises an upper rotor plate 52a similar to the lower rotor plate 51a; on the upper rotor plate 52a are formed a central opening 52c fitting outside the rib 37 of the upper plate 30, a notch 52e corresponding to the depression 34 and a rib 52d corresponding to the upper rotor support groove 38. In addition, at a portion adjacent to the notch 52e of a peripheral rim of the upper rotor plate 52a is formed a shutter groove 52b, corresponding to the shutter plate 51b of the lower rotor 51. The shutter guiding groove 52b has a fitted portion 52f and receiving opening portion 52g as shown in FIG. 7. The fitted portion 52f has substantially same shape as the edge portion 51h of the shutter plate 51b which is particularly a rectangular shape. The receiving opening portion 52g is formed in a shape that the enter direction for the shutter guiding groove has the wider groove than the reverse direction and particularly has a chamfer cutting shape of the opening portion 52g. By mating the shutter guiding groove 52b with the edge portion 51h of the shutter plate 51b, the lower rotor 51 and the upper rotor 52 is coupled via the shutter plate 51b and is integrally rotated by a shutter open/close mechanism as discussed later.

The upper rotor 52 is rotationally freely supported by the upper plate 30 by the central opening 52c fitting outside the rib 37 of the upper plate 30 and the rib 52d engaging in the upper rotor support groove 38. Meanwhile, the upper rotor 52 is prevented from dropping from the upper plate 30 by a stop member 53. The stop member 53 comprises a cylindrical portion 53a inserted in the rib 37 (see FIG. 3) and a flange 53b formed at one end of the cylindrical portion 53a; the cylindrical portion 53a is inserted in the central opening 52c from a lower side of the upper rotor 52 and is fixed at the rib 37 by ultrasonic welding, adhesion and the like.

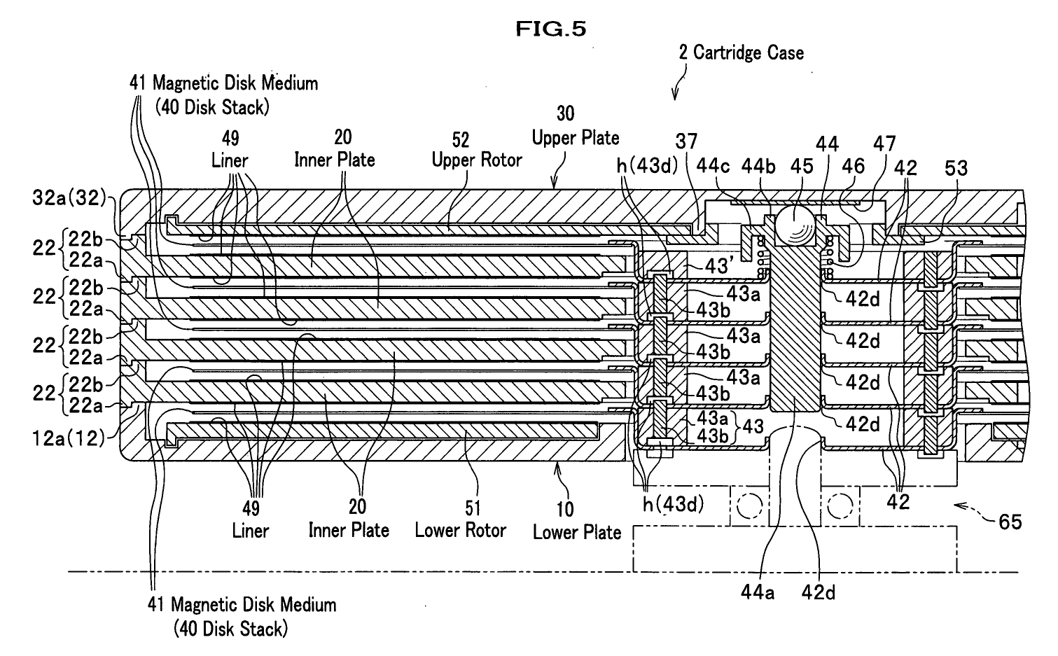

As an enlarged section drawing shown in FIG. 5, an upper face of the lower rotor 51, upper and lower faces of the inner plates 20 and a lower face of the upper rotor 52 are faces opposing the magnetic disk media 41, where liners 49 are affixed across portions opposing the media 41, respectively.

The liners 49 consist of, for example, a non-woven cloth such as a polyester fiber and a blended fabric fiber of rayon and polyester.

Next will be described a stack structure of the lower plate 10, the inner plates 20 and the upper plate 30.

In the rib 12 of the lower plate 10, as shown in FIG. 5, an inside thereof is formed higher by one step than an outside thereof and thereby a male type step portion 12a is formed; each rib 22 of the inner plates 20 forms a female type step portion 22a protruding downward at outermost periphery and thus a periphery of the male type step portion 12a and an inner perimeter of the female type step portion 22a become able to be fitted. In addition, when the lower plate 10, the inner plates 20 and the upper plate 30 are fastened by the screws 91 (see FIG. 1), an upper face of the male type step portion 12a and a corresponding portion of a lower face of the lowermost inner plate 20 are designed to be contacted. Thus, because the rib 12 of the lower plate 10 and the rib 22 of the inner plate 20 are sealingly abutted and fitted each other, an invasion of dust into the cartridge case 2 from outside is prevented.

Similarly, any adjacent two of the inner plates 20 and the uppermost inner plate 20 and the upper plate 30 are stacked by being sealingly abutted and fitted each other. In other words, on an upper face of each of the inner plates 20 is formed a male type step portion 22b where an inside of the upper face is formed higher by one step; at a rib 32 of the upper plate 30 is formed a female type step portion 32a of which outermost periphery protrudes downward by one step. And the male type step portion 22b of one inner plate 20 and the female type step portion 22a of an upper adjacent inner plate 20 are sealingly abutted and fitted each other; the male type step portion 22b of the uppermost inner plate 20 and the female type step portion 32a of the upper plate 30 are sealingly abutted and fitted, and stacked. Thus any adjacent two of the ribs 12, 22, 32 are sealingly abutted and fitted each other and dust from outside is prevented from invading into the cartridge case 2. In addition, as soon as the lower plate 10, the inner plates 20 and the upper plate 30 are stacked, the side wall 13 of the cartridge case 2 is configured.

In addition, both of the female type step portion 22a and the male type step portion 22b protrude from the main plate 21 beyond a thickness of the liner 49. Therefore, after affixing the liners 49 on the inner plates 20 and making an assembly, then even if placing it on a work bench, the liners 49 do not contact the work bench and accordingly, are not contaminated with dust and the like.

Such the configuration of the cartridge case 2 by stacking the inner plates 20 facilitates a change of a number of the magnetic disk media 41; although a height change of the side wall 13 and that of the shutter plate 51b are requested, a number of housing units of the magnetic disk media 41 formed within the cartridge case 2 can be changed only by mainly changing a number of the inner plates 20.

Next will be described the magnetic disk media 41 and a stack structure thereof. The magnetic disk media 41 are ones where magnetic paint is coated on both faces of a resin sheet, for example, such as polyester.

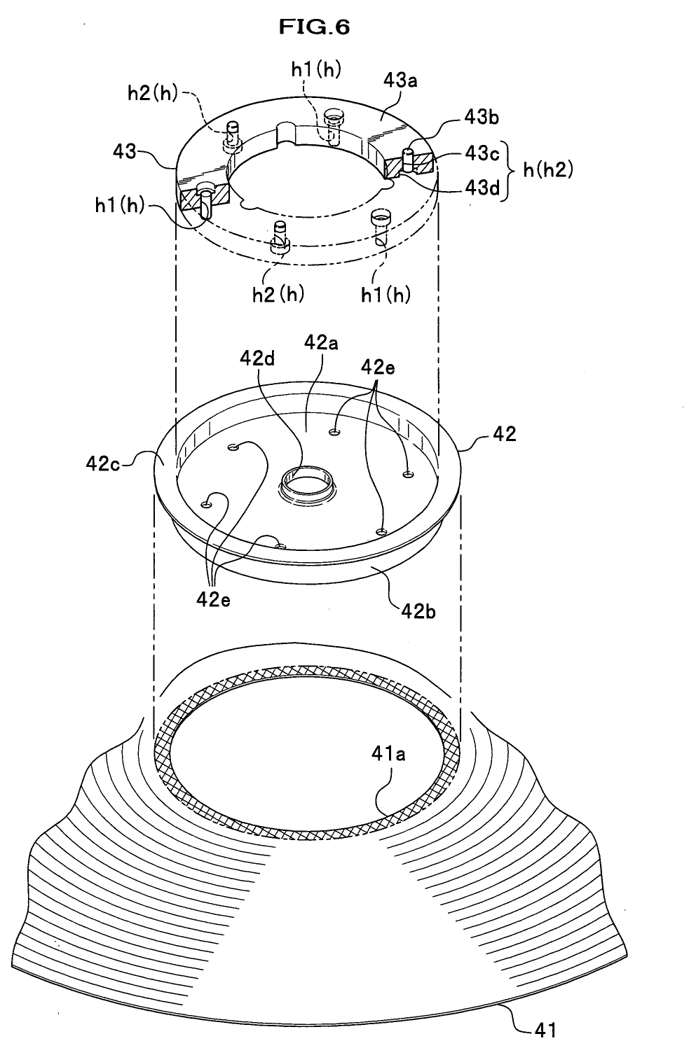

As shown in FIG. 6, each of the center cores 42 is one substantially made a hat form with draw forming a metal plate by press: the center core 42 is mainly configured of a circular bottom plate 42a, a low cylindrical side wall 42b rising from peripheral rim of the bottom plate 42a and a flange 42c widening in an outer diameter direction from an upper end of the side wall 42b. At center of the bottom plate 42a is formed a center hole 42d and at rim of the plate 42a are formed six small holes 42e at a distance of 60 degrees, making the center hole 42d a center thereof.

A spacer 43 is provided between adjacent center cores 42, keeps a distance of each of the center cores 42, stops a rotation between each of the center cores 42, and functions so that the stacked magnetic disk media 41 integrally rotate. The spacer 43 is mainly configured of a main body portion 43a shaped like a ring from a resin and metallic pins 43b pressed into the main body portion 43a. In the main body portion 43a are formed six penetration holes h at positions corresponding to the small holes 42e of the center core 42, wherein each of the penetration holes h consists of a small diameter hole portion 43c, where the pin 43b is pressed and a large diameter hole portion 43d that is coaxial with and slightly larger in diameter than the small diameter hole portion 43c. The six penetration holes h are designed to be upside down in any two adjacent ones. In other words, penetration holes h2 of both adjacent penetration holes h1, where each the large diameter hole portion 43d is positioned at an upper side thereof, are arranged so that the large diameter hole portion 43d is positioned at a lower side thereof.

Into each of the small diameter portions 43c is pressed each one pin 43b from upper/lower sides thereof, one end of the pin 43b is positioned at a boundary of the large diameter hole portion 43d and the small diameter hole portion 43c and the other end thereof protrudes outside the small diameter portion 43c. The large diameter hole portion 43d serves a function of a clearance at ends of pins 43b of adjacent spacers 43.

As shown in FIG. 5, such the spacers 43 are provided between adjacent center cores 42, respectively. One pin 43b protruding toward a lower side of each of the spacers 43 enters in a small hole 42e of one center core 42 at the lower side of the spacer 43 and stops a rotation relative to the center core 42 at the lower side. If there is another spacer 43 at a still lower side than the center core 42 at the lower side, a floating-up of the spacer 43 for the center core 42 is prevented by the pin 43b entering the large diameter hole portion 43d in the spacer 43 at the lower side. The other pin 43b protruding toward an upper side of the spacer 43 enters in a small hole 42e of the other center core 42 at the upper side of the spacer 43 and stops a rotation relative to the center core 42 at the upper side. If there is another spacer 43 at a still upper side than the center core 42 at the upper side, the top end of the pin 43b enters in the large diameter hole portion 43d in the spacer 43 at the upper side.

Meanwhile, because at an upper side the uppermost center core 42 has no center core 42 to stop a rotation thereof, at the upper side is arranged a thin top spacer 43′ in thickness where the pin 43b is protruded only downward.

The magnetic disk media 41 thus stacked, namely, the disk stack 40, are stably supported in rotation by a coupling shaft 44, a bearing ball 45, a compression coil spring 46 and a center plate 47.

As shown in FIG. 5, the coupling shaft 44 lessens a central fluctuation between the center cores 42 stacked, holds the bearing ball 45 and the compression coil spring 46 and comprises a shaft portion 44a, a ball holding portion 44b and a spring holding portion 44c. The shaft portion 44a is a columnar form that can be inserted through the center holes 42d of the center cores 42. At an upper end of the shaft portion 44a the ball holding portion 44b is formed into a cylindrical form with a bottom opening to an upper side thereof. A depth of the ball holding portion 44b is larger than a radius of the bearing ball 45 and therefore, the bearing ball 45 is stably held at the ball holding portion 44b. The spring holding portion 44c consists of a form where a cylindrical form with a bottom is turned down at a side of an outer diameter of the ball holding portion 44b and the compression coil spring 46 is arranged in a cylindrical space between the shaft portion 44a and the spring holding portion 44c. Meanwhile, although a length of the coupling shaft 44 is arbitrary, in the embodiment it is one reaching the second center core 42 from the lowermost one; the center hole 42d of the lowermost center core 42 is opened so that a spindle 65 of a magnetic disk drive can proceed.

The center plate 47 is a slide member affixed at the center of an inner face of the upper plate 30, that is, on a flat face of an inside of the rib 37. The center plate 47 can be composed of, for example, a material excellent in sliding ability and abrasion resistance such as polyoxymethylene and ultra high molecular weight polyethylene.

Although the bearing ball 45 consists of a sphere made of, for example, steel used for a ball bearing, it may also be composed of a material excellent in sliding ability and abrasion resistance, for example, such as polytetrafluoroethylene and polyoxymethylene. The bearing ball 45 is arranged within the ball holding portion 44b of the coupling shaft 44, abuts with the bottom face of the ball holding portion 44b; and a center of an inner face of the upper plate 30, that is, the center plate 47 by a point contact and rotationally supports the disk stack 40.

In the compression coil spring 46 one end (upper end) is held by the spring holding portion 44c of the coupling shaft 44; the other end (lower end) abuts with an upper face of the uppermost center core 42 and energizes the stacked center cores 42 to the side of the lower plate 10, that is, to the side of the spindle 65 of the magnetic disk drive. Thus the center cores 42 do not jounce within the cartridge case 2 and the fluctuation of the magnetic disk media 41 is prevented in rotation thereof.

A magnetic disk drive for recoding/reproducing data for the magnetic disk cartridge 1 rotates, as shown in FIG. 4, the disk stack 40 by the spindle 65. The spindle 65 attracts the lowermost center core 42 by magnetic force, enters in the center hole 42d of the center core 42 and thereby matches an axis thereof with that of the disk stack 40. At this time, because the spindle 65 slightly lifts up the center cores 42 with resisting an energizing force of the compression coil spring 46, as shown in FIGS. 4 and 5, each of the magnetic disk media 41 is positioned at center of a space formed between the lower rotor 51 and the lowermost inner plate 20, between upper and lower inner plates 20 and between the uppermost inner plate 20 and the upper rotor 52. The magnetic heads 63 are provided at top ends of swing arms 62. Each of the magnetic heads 63 is arranged on both faces of each of the magnetic disk media 41.

The magnetic disk cartridge 1 thus described can prevent, in no use thereof as shown in FIG. 2A, an invasion of dust thereto by closing the opening 3 with rotating the shutter 4 in a counterclockwise direction of the drawing; in use thereof as shown in FIG. 2B, when loaded on the magnetic disk drive, the shutter open gear 67 fits in the groove 13a, is guided thereby, engages in the gear 51f and rotates the shutter 4 in a clockwise direction of the drawing.

Since the lower rotor 51 on which a gear 51f is formed is coupled with the upper rotor 52 via shutter plate 51b in this particular case, the shutter 43 integrally rotates in a clockwise in FIG. 2B. According to this rotation, the shutter plate 51b that shuts off the case opening 3 and disk stack 40 moves away from the case opening 3 and then the disk stack 40 is opened.

In addition, the disk stack 40 rotates by the spindle 65 rotating. After then, the swing arms 62 rotate by being driven with an actuator 61 and each of the magnetic heads 63 are moved onto each face of the magnetic disk media 41.

On the other hand, when the recording disk cartridge 1 is ejected from the magnetic disk drive, the shutter open gear 67 to which the gear 51f matches moves in a reverse direction to the time of inserting the recording disk cartridge and makes the gear 51f rotate counter clockwise in the figure. According to this rotation, the shutter 4 rotates in counter clockwise and the case opening 3 is shut off.

When recording data on the magnetic disk media 41 with the magnetic heads 63, the data is recorded thereon by sending a signal to the magnetic heads 63 by a control circuit not shown; when reproducing data from the magnetic disk medium 41, a signal is output by detecting a change of a magnetic field on the medium 41 with the magnetic heads 63a.

At this time, dust on the magnetic disk media 41 is removed by the liners 49 appropriately touching respective media 41.

After the use of the magnetic disk cartridge 1, the magnetic heads 63 are retracted from the cartridge case 2, thereafter ejects the magnetic disk cartridge 1; thereby the gear 51f is driven by the shutter open gear 67 and the shutter 4 closes the opening 3.

Thus because the magnetic disk cartridge 1 has a plurality of the magnetic disk media 41, data transfer can be performed at a higher speed by simultaneously accessing data with a plurality of magnetic heads 63.

In addition, because the cartridge case 2 is configured by stacking up the inner plates 20, it is easy to perform a specification change of making a number of magnetic disk media 41 a different one. Then, in assembling the magnetic disk cartridge 1, because the magnetic disk media 41 can be handled with being placed on the inner plates 20 and the lower rotor 51 built in the lower plate 10, an occasion of touching the magnetic disk media 41 can be reduced and a quality of the cartridge 1 can be further stabilized.

In addition, because each of the inner plates 20 is stacked on the lower plate 10 or another inner plate 20 and is fixed, the magnetic disk cartridge 1 can make it higher a parallelism to the magnetic disk media 41, can stabilize a rotation of the media 41 and enable a higher speed rotation of the media 41, furthermore a higher speed of a data transfer.

Another embodiment of the present invention is discussed with the figures. FIG. 7 and FIG. 8 shows cross sectional views of the matching of the shutter plate and the upper rotor. FIG. 7 shows the embodiment previously provided and FIG. 8 shows another embodiment.

The shutter plate 51b in this embodiment has a sealing off portion 51i that shuts off between the case opening 3 (see FIG. 2A) and the disk stack 40 and has an edge portion 51h mating with the shutter guiding groove 52b formed in the upper rotor 52. The edge portion 51h has a shape of sharpening towards the edge, which is a chamfer cutting shape for this particular case. It is preferable that the shutter guiding groove 52b has wider groove in the enter portion 52g to the edge portion 51h in addition.

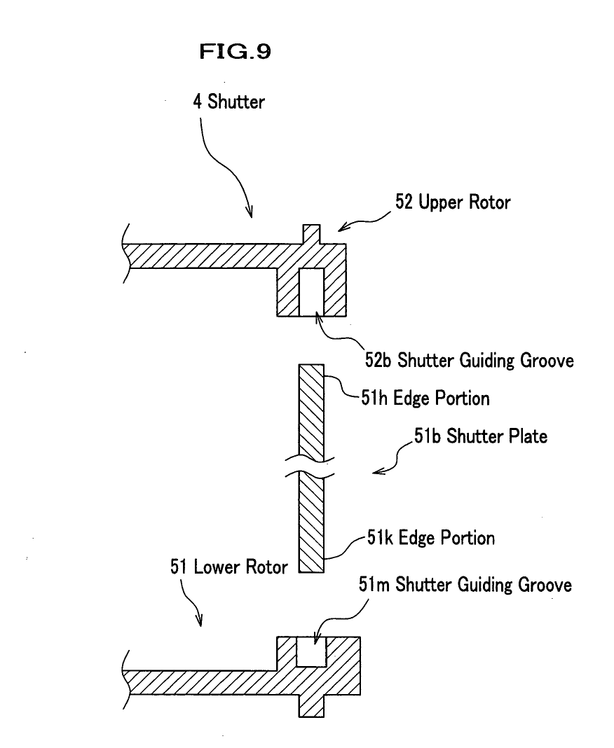

FIG. 9 shows a section view of the mating of the parts composing the shutter regarding another embodiment. As shown in FIG. 9, the shutter 4 is composed of the lower rotor 51, the upper rotor 52 and the shutter plate 51b which are all independent components but are mutually mating. On the lower rotor 51, a shutter guiding groove 51m is formed at the position facing against the shutter guiding groove 52b formed in the upper rotor 52. The edge portion 51k of the shutter plate 51b and the shutter guiding groove 51m formed in the lower rotor 51 are fitted, the edge portion 51h of the shutter plate 51b and the shutter groove 52b are fitted and ultimately construct the shutter 4. The shutter guiding grooves 51m and 52b are preferred to have wide opening at the enter portion and it is preferred that the edges 51h and 51k are formed in a sharpen shape as shown in FIG. 8.

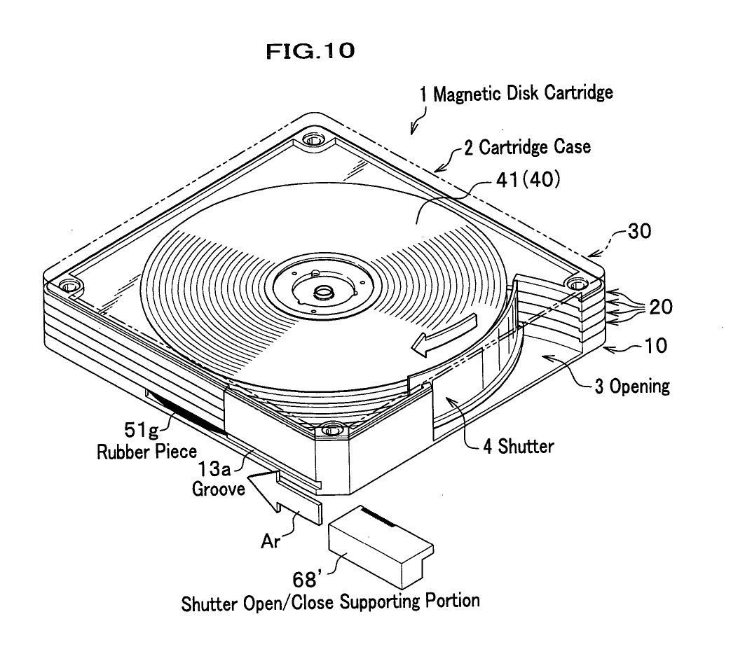

FIG. 10 shows an external perspective view of the recording disk cartridge which is closed, particularly, another embodiment of the mating portion of the shutter open/close mechanism. As shown in FIG. 10, the mating portion of another embodiment is not confined in the gear 51f as previously described but can be formed with high friction material such as rubber material as a rubber piece 51g. In this particular embodiment, a rubber piece 51g is fixed with an adhesive in the predetermine range adjacent to the shutter plate 51b in the peripheral of the lower rotor plate 51a (see FIG. 1). When the mating portion is made of the rubber piece 51g as shown in FIG. 10, a shutter open/close supporting portion 68′ of which surface is roughed at the part with which the rubber piece 51g mates the shutter open/close supporting portion 68 formed in the disk drive is preferably used. The present embodiment has the mating portion in the lower rotor 51 but can have it in the upper rotor 52.

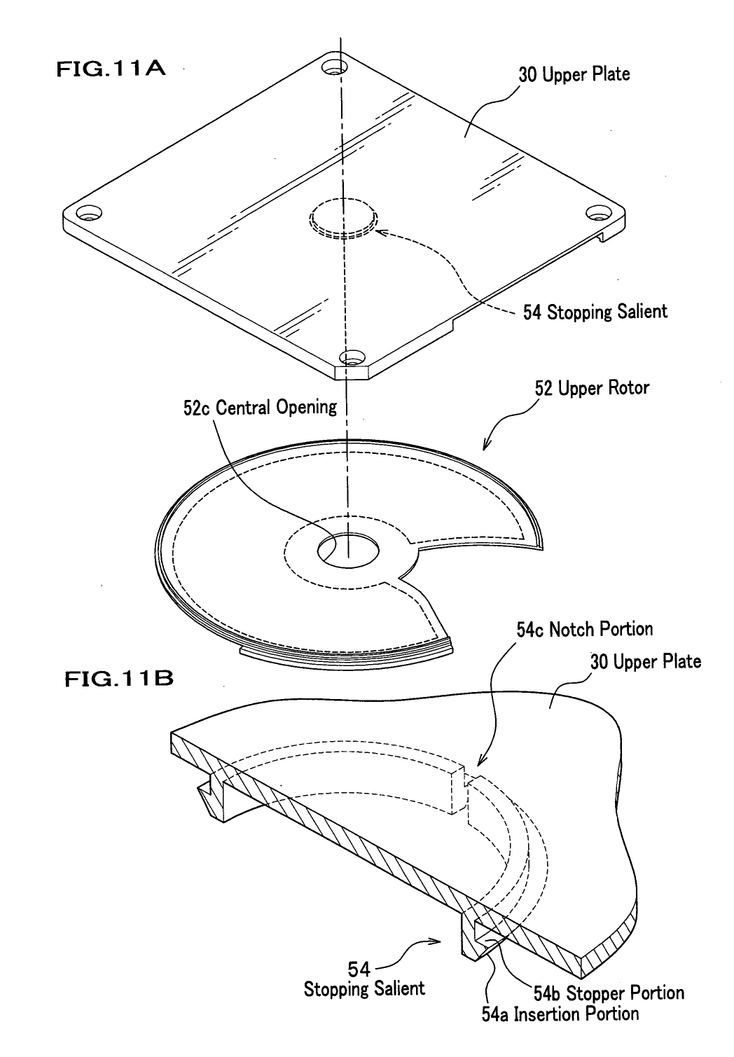

FIG. 11A and FIG. 11B are perspective views that show the inner surface of the upper plate. FIG. 11A shows the relation between the upper rotor and the upper plate. FIG. 11B shows another embodiment wherein the upper rotor is stopped on the upper plate. As shown in FIG. 11A and FIG. 11B, a stopping salient 54 which is another embodiment of the stopper is formed in a single block. The rib, called a stopping salient 54 in these particular embodiments, is a variation of the rib and can be an alternative technology to the ribs 17 and 37. The stopping salient 54 is a projected portion of an annular which has an insertion portion 54a, a stopper portion 54b and a notch portion 54c that has no insertion portion 43a or stopper portion 54b therein. The insertion portion 54a is formed in a taper shape such that the outer diameter gradually becomes large against the upper plate 30 and the insertion portion 54a is easily fitted to the central opening 52c. The stopping salient 54 is easily deformed when the central opening 52c is pressed to the insertion portion 54a since the notch 54c is made. The central opening is fitted to the stopping salient 54 so that the upper rotor 52 is not dropped off from the upper plate 30.

Thus, although the embodiment of the present invention is described, the invention is not limited thereto and can be embodied with being changed as needed. For example, although in the embodiment the magnetic disk medium 41 is applied to a recording disk medium, an optical recording medium where data is recorded by light can also be applied thereto.

In addition, although in the embodiment the lower plate 10, the inner plates 20 and the upper plate 30 are fastened and fixed by the screws 91, they can also be integrally fixed by any of adhesion and deposition.

What is claimed is:

1. A recording disk cartridge comprising a plurality of flexible recording disk media integrally rotatably housed within a cartridge case, the case comprising:
a lower plate for configuring a lower wall parallel to said plurality of the recording disk media;
at least one inner plate that is stacked and fixed on said lower plate and partitions said plurality of the recording disk media; and
a shutter that opens and closes a case opening which is formed in a portion of a side wall configured by the lower plate, the inner plate and the upper plate,
wherein the shutter comprises a lower rotor which is rotatably supported in an inner side of the lower plate, an upper rotor which is rotatably supported in an inner side of the upper plate and a shutter plate that couples both the lower rotor and the upper rotor and shuts off the case opening.

2. A recording disk cartridge according to claim 1, wherein the shutter plate is formed in a single block with either the lower rotor or the upper rotor.

3. A recording disk cartridge according to claim 1, wherein the lower rotor, the upper rotor and the said shutter plate are physically independent parts and are mutually coupled to compose the shutter.

4. A recording disk cartridge according to claim 1, wherein at least either the lower rotor or the upper rotor has a shutter guiding groove wherein the shutter guiding groove has a wider opening at a mating surface to the shutter plate.

5. A recording disk cartridge according to claim 1, wherein the shutter plate has an edge that mates with the shutter guiding groove which is made in at least either the lower rotor or the upper rotor and has a shape of sharpening towards the edge.

6. A recording disk cartridge according to claim 4, herein the shutter plate has an edge that mates with the shutter guiding groove and has a shape of sharpening towards the edge.

7. A recording disk cartridge according to claim 1, wherein the shutter plate has a mating portion which mates with shutter open/close supporting portion formed in the disk drive so that the mating portion transmits a rotation force.

8. A recording disk cartridge according to claim 7, wherein the mating portion includes a gear.

9. A recording disk cartridge according to claim 7, wherein the mating portion is made of high friction material.

10. A recording disk cartridge according to claim 7, wherein the mating portion is made of rubber.

11. A recording disk cartridge according to claim 7, wherein the mating portion is formed in at least either the lower rotor or the upper rotor.

12. A recording disk cartridge according to claim 1, wherein the upper plate is fitted to the stopping salient formed with the upper plate in a single block.

13. A recording disk cartridge according to claim 1, wherein the lower rotor has a central opening and a substantially circular plate that has a rib formed downward at a peripheral rim of the lower rotor, the central opening is rotationally freely fitted to the lower rotor that a rib formed at center of the upper surface of the lower rotor supports and the lower plate is supported by mating the rib with a circular lower rotor support groove formed in the upper surface of the lower plate.

14. A recording disk cartridge according to claim 1, wherein the upper rotor has a central opening and a substantially circular plate that has a rib formed upward at a peripheral rim of the upper rotor, the central opening is rotationally freely fitted to the upper rotor that a rib formed at center of the lower surface of the upper rotor supports and the upper plate is supported by mating the rib with a circular upper rotor support groove formed in the lower surface of the upper plate.

15. A recording disk cartridge according to claim 14, wherein the rib that supports upper rotor has an insertion portion with substantially annular shape, a rib formed in a taper shape such that outer diameter gradually becomes large against the upper plate, the circular length of the upper annular of the rib is larger than the circular length of the opening that the upper rotor has so that the upper rotor is fitted to the rib.

16. A recording disk cartridge according to claim 15, wherein the circular length of the lower rim is shorter than the circular length of the opening of the upper rotor.

17. A recording disk cartridge according to claim 16, wherein the insertion portion is formed in a taper shape from the upper rim to the lower rim.

18. A recording disk cartridge according to claim 15, wherein the rib that supports upper rotor has one or more notches so that the rim is easily elastically deformed in an inner direction.

19. A recording disk cartridge according to claim 1, wherein the disk media are magnetic disk media.

20. A recording disk cartridge according to claim 1, wherein the disk media are optical disk media.
